(19) United States
(12) Patent Application Publication
(10) Pub. No.: US 2026/0316456 A1
(43) Pub. Date: Oct. 15, 2026

(54) LIQUID EJECTION HEAD AND LIQUID EJECTION APPARATUS

(71) Applicant: CANON KABUSHIKI KAISHA, Tokyo (JP)

(72) Inventors: TOMOHIRO SATO, Tokyo (JP); YOHEI NAKAMURA, Kanagawa (JP); KATSUHIRO MATSUDA, Kanagawa (JP)

(21) Appl. No.: 19/644,132

(22) Filed: Apr. 10, 2026

(30) Foreign Application Priority Data
Apr. 11, 2025 (JP) 2025-065444

(51) Int. Cl. B41J 2/18; B41J 2/045; B41J 2/14; B41J 2/175

(52) U.S. Cl. CPC B41J 2/18; B41J 2/04581; B41J 2/04596; B41J 2/14233; B41J 2/17596; B41J 2002/14258

(57) ABSTRACT

A technique is provided for suppressing deterioration of a piezoelectric actuator in a liquid ejection apparatus that performs vibration of a meniscus and circulation of ink in a flow path using the piezoelectric actuator. For this purpose, the piezoelectric actuator has a piezoelectric body having a first piezoelectric layer and a second piezoelectric layer stacked in an up-down direction, the first piezoelectric layer is configured to be provided sandwiched between a first electrode and a second electrode in the up-down direction, and the second piezoelectric layer is configured to be provided sandwiched between the second electrode and a third electrode in the up-down direction.

### BACKGROUND

### Field of the Technology

The present disclosure relates to a liquid ejection head and a liquid ejection apparatus.

### Description of the Related Art

Japanese Patent Laid-Open No. 2021-11085 discloses a liquid ejection head in which a circulation path is formed such that ink passes from a supply port through a supply manifold, a supply path, a pressure chamber, and a descender to reach an ejection port, and ink that has not been ejected from the ejection port flows through a return path and a return manifold to a return port. Furthermore, in the liquid ejection head of Japanese Patent Laid-Open No. 2021-11085, a circulation flow is created by driving a pressurizing pump upstream of the supply port and a negative pressure pump downstream of the return port.

In the liquid ejection head disclosed in Japanese Patent Laid-Open No. 2021-11085, the supply manifold and the return manifold extend in a direction in which a plurality of ejection ports are arranged, and supply or return ink in common to the plurality of ejection ports. A supply port is arranged at one extending end of the supply manifold, and a return port is arranged at one extending end of the return manifold. In a case where circulation is performed by pumps in such an arrangement, pressure loss differs depending on a distance from the supply port and the return port in a plurality of circulation flow paths respectively corresponding to the plurality of ejection ports arranged in the extending direction. Therefore, a difference occurs in a circulation flow rate depending on a position of the circulation flow path. As a result, a difference occurs in an agitation state for each circulation path, and a viscosity change occurs in ink in the vicinity of the ejection port of a circulation path having a poor agitation state. Then, due to the viscosity change of the ink, there is a possibility that deterioration of printing quality or ejection failure is caused.

In order to suppress the viscosity change of the ink, a method is known in which a piezoelectric actuator, which is installed adjacent to the pressure chamber and driven for an ejection operation, is driven with energy different from that for the ejection operation. If this method is adopted, it becomes possible to promote agitation of the ink while causing meniscus vibration at the ejection port, and to uniformize viscosity of the ink at each ejection port. However, in that case, if it is attempted to uniformize the viscosity in the entire ejection ports, a difference occurs in an appropriate number of drives in each piezoelectric actuator depending on the position of the ejection port. On the other hand, it is known that the piezoelectric actuator has a life, and the life becomes shorter as the number of drives increases. Therefore, there is a possibility that the life of the liquid ejection head is shortened due to deterioration of a piezoelectric actuator having a large number of drives, that is, an actuator at a position far from the supply port.

### SUMMARY

Therefore, the present disclosure provides a technique for promoting a longer life of a liquid ejection head in a liquid ejection apparatus that performs vibration of a meniscus and circulation of ink in a flow path using a piezoelectric actuator.

Therefore, the liquid ejection apparatus of the present disclosure is a liquid ejection apparatus including: an ejection port that ejects a liquid; a pressure chamber that communicates with the ejection port; a piezoelectric actuator that applies pressure to the liquid accommodated in the pressure chamber; an individual supply flow path for supplying the liquid to the pressure chamber; an individual collection flow path for collecting the liquid from the pressure chamber; a common supply flow path for supplying the liquid in common to a plurality of the individual supply flow paths; a common collection flow path for collecting the liquid in common from a plurality of the individual collection flow paths; a differential pressure generation unit that generates a pressure difference between the common supply flow path and the common collection flow path; and a control unit that controls driving of the piezoelectric actuator, wherein the liquid is caused to flow from the common supply flow path to the common collection flow path via a plurality of the pressure chambers by the differential pressure generated by the differential pressure generation unit, and wherein the piezoelectric actuator has a plurality of piezoelectric layers stacked in a first direction, and a first electrode, a second electrode, and a third electrode provided at different positions in the stacking direction so as to sandwich the piezoelectric layers different from each other.

According to the present disclosure, in a liquid ejection apparatus that performs vibration of a meniscus and circulation of ink in a flow path using a piezoelectric actuator, it is possible to provide a technique for promoting a longer life of the piezoelectric actuator.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing a liquid ejection apparatus;

FIG. 2A is a perspective view showing a liquid ejection head;

FIG. 2B is a perspective view showing the liquid ejection head;

FIG. 3 is an exploded perspective view of the liquid ejection head;

FIG. 4 is a cross-sectional view showing a liquid ejection unit;

FIG. 5A is a diagram showing a liquid ejection substrate;

FIG. 5B is a diagram showing the liquid ejection substrate;

FIG. 5C is a diagram showing the liquid ejection substrate;

FIG. 6A is a diagram showing a liquid ejection substrate;

FIG. 6B is a diagram showing the liquid ejection substrate;

FIG. 7A is a diagram showing a liquid ejection substrate;

FIG. 7B is a diagram showing the liquid ejection substrate;

FIG. 8 is a diagram showing a cross section taken along line VIII-VIII of FIG. 5A;

FIG. 9 is a diagram showing a cross section taken along line VIII-VIII of FIG. 5A;

FIG. 10 is a diagram showing a cross section taken along line VIII-VIII of FIG. 5A;

FIG. 11 is a diagram showing a cross section taken along line VIII-VIII of FIG. 5A;

FIG. 12A is a schematic view of a pressure chamber 5 viewed from an up-down direction;

FIG. 12B is a diagram showing a cross section taken along line XIIB-XIIB in FIG. 12A; and

FIG. 12C is a diagram showing a cross section taken along line XIIC-XIIC in FIG. 12A.

### DESCRIPTION OF THE EMBODIMENTS

### First Embodiment

Hereinafter, a first embodiment of the present disclosure will be described with reference to the drawings. The present embodiment is an inkjet printing apparatus in a form in which a liquid such as ink is circulated from a tank via a liquid ejection head. However, other forms may be adopted; for example, a form may be adopted in which two tanks are provided on an upstream side and a downstream side of the liquid ejection head without circulating ink, and ink in a pressure chamber is caused to flow by flowing the ink from one tank to the other tank.

Further, the present embodiment is a so-called line type head having a length corresponding to a width of a printing medium, but the present disclosure is also applicable to a so-called serial type liquid ejection head that performs printing while scanning the printing medium. As the serial type liquid ejection head, for example, a configuration in which one printing element substrate for black ink and one printing element substrate for color ink are mounted can be cited. However, the present disclosure is not limited to this, and a form may be adopted in which a short line head shorter than the width of the printing medium is created by arranging several printing element substrates so that ejection ports overlap in an ejection port array direction, and the line head is caused to scan the printing medium.

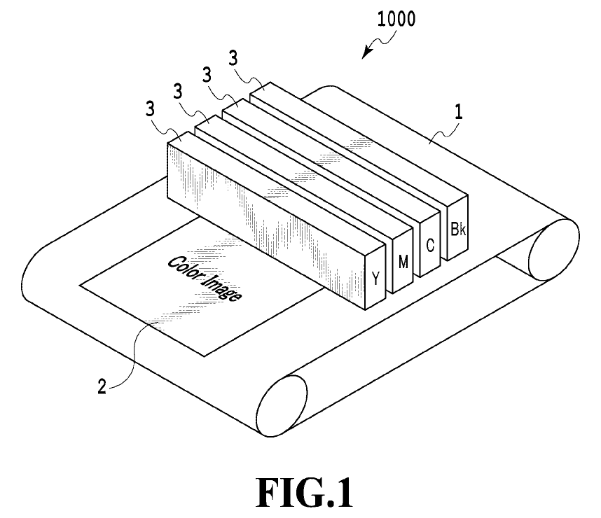

FIG. 1 is a schematic diagram showing a liquid ejection apparatus 1000 to which the present embodiment is applicable. The liquid ejection apparatus 1000 includes a transport unit 1 that transports a printing medium 2, and can mount a line type liquid ejection head 3 arranged substantially orthogonal to a transport direction of the printing medium 2. The liquid ejection apparatus 1000 is a line type printing apparatus that performs continuous printing in one pass while transporting a plurality of printing media 2 continuously or intermittently. The printing medium 2 is not limited to cut paper but may be continuous roll paper.

The liquid ejection apparatus 1000 performs full-color printing on the printing medium 2 by arranging four monochromatic liquid ejection heads 3 corresponding to respective inks of CMYK in parallel. To the liquid ejection head 3, as will be described later, a liquid supply unit which is a supply path for supplying a liquid to the liquid ejection head, a main tank, and a buffer tank are fluidly connected. Further, an electric control unit that transmits electric power and ejection control signals to the liquid ejection head 3 is electrically connected to the liquid ejection head 3. A liquid path and an electric signal path in the liquid ejection head 3 will be described later.

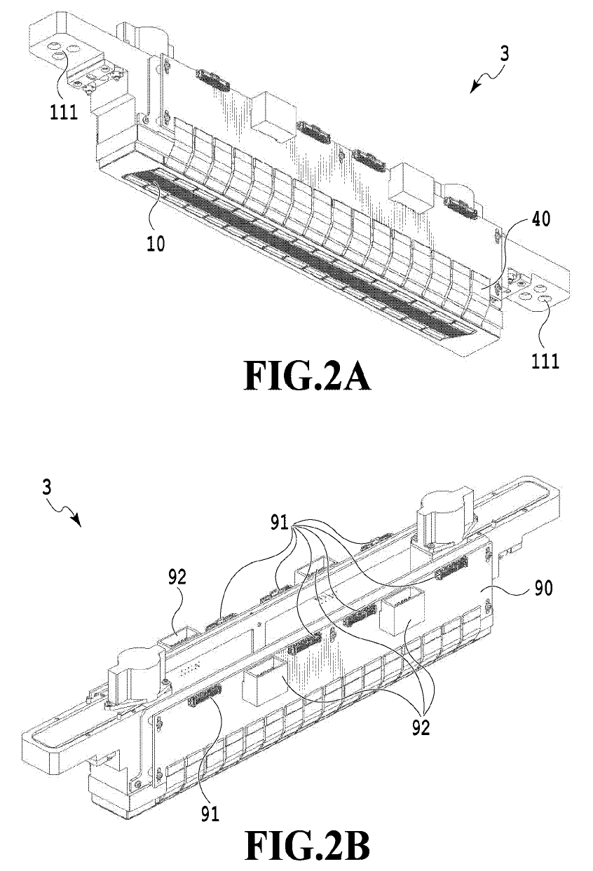

In the present embodiment, a monochromatic head is used, but a configuration capable of full-color printing (cyan, magenta, yellow, black) with CMYK inks by one head may be adopted. Further, in the present embodiment, printing element substrates 10 (see FIG. 2A described later) are arranged in-line, but they may be in a staggered arrangement. Furthermore, it goes without saying that the shape of the printing element substrate 10 can take various forms.

FIGS. 2A and 2B are perspective views showing the liquid ejection head 3. The liquid ejection head 3 includes 16 printing element substrates 10 (also referred to as liquid ejection substrates) arranged linearly in a longitudinal direction of the liquid ejection head 3, and is an inkjet type line printing head capable of printing with one color liquid. As shown in FIGS. 2A and 2B, the liquid ejection head 3 includes signal input terminals 91 and power supply terminals 92 electrically connected to the respective liquid ejection substrates 10 via flexible wiring boards 40 and an electric wiring board 90. The signal input terminals 91 and the power supply terminals 92 are electrically connected to a control unit of the liquid ejection apparatus 1000, and supply ejection drive signals and electric power necessary for ejection to the liquid ejection substrate 10, respectively. As shown in FIG. 2A, liquid connection portions 111 provided at both ends of the liquid ejection head 3 are connected to a liquid supply system of the liquid ejection apparatus 1000. Thereby, ink is supplied from the supply system of the liquid ejection apparatus 1000 to the liquid ejection head 3, and the ink that has passed through the inside of the liquid ejection head 3 is recovered to the supply system of the liquid ejection apparatus 1000. Thus, ink of each color can circulate via the path of the liquid ejection apparatus 1000 and the path of the liquid ejection head 3. In the present embodiment, the liquid ejection head 3 shows a head that circulates monochromatic ink, but it may be a liquid ejection head in which liquid ejection substrates 10 capable of ejecting four colors of ink of C/M/Y/K with one liquid ejection substrate 10 are arranged in-line.

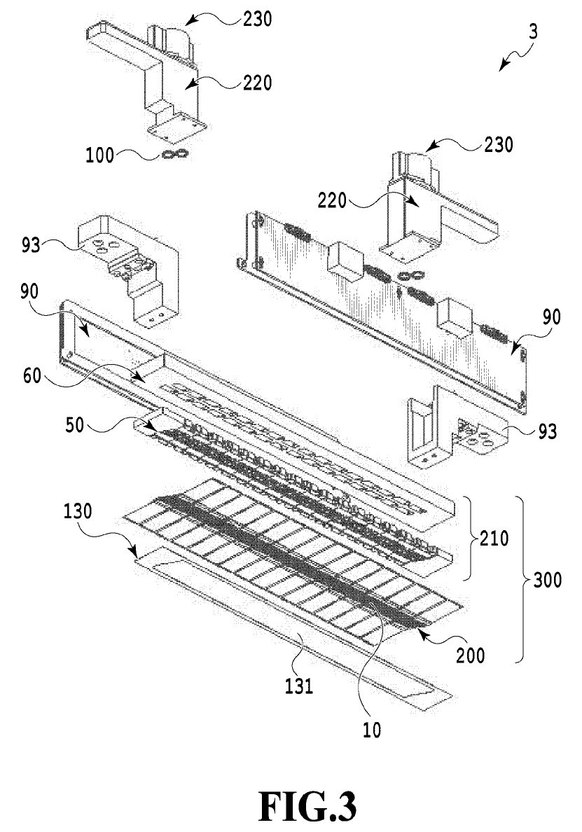

FIG. 3 is an exploded perspective view of the liquid ejection head 3. The liquid ejection head 3 in the present embodiment includes a liquid ejection unit 300. The liquid ejection unit 300 includes a flow path member 210, a plurality of ejection modules 200, and a cover member 130. Further, the flow path member 210 includes a first flow path member 50 and a second flow path member 60. A support portion 93 is connected to both ends of the second flow path member 60 and supports the entire liquid ejection head 3. The liquid ejection unit 300 is mechanically coupled to a carriage of the liquid ejection apparatus 1000 to perform positioning of the liquid ejection head 3. A liquid supply unit 220 including a negative pressure control unit (differential pressure generation unit) 230 and the electric wiring board 90 are coupled to the liquid ejection unit support portion 93. A filter (not shown) is built in each of the two liquid supply units 220 to remove foreign matter in the supplied ink. The two negative pressure control units 230 are set to control pressure with different relative high and low negative pressures, respectively.

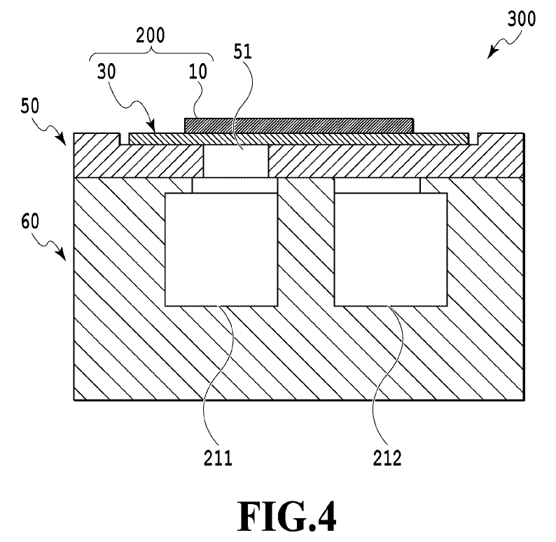

Next, details of the flow path member 210 of the liquid ejection unit 300 will be described. As shown in FIG. 3, the flow path member 210 is formed by laminating the first flow path member 50 and the second flow path member 60, and distributes the liquid supplied from the liquid supply unit 220 to each ejection module 200. Further, the flow path member 210 functions as a flow path member for returning the liquid circulating from the ejection module 200 to the liquid supply unit 220. The second flow path member 60 of the flow path member 210 is a flow path member in which a common supply flow path 211 (see FIG. 4 described later) and a common collection flow path 212 (see FIG. 4 described later) are formed, and also has a function of mainly bearing rigidity of the liquid ejection head 3. For this reason, as a material of the second flow path member 60, a material having sufficient corrosion resistance to liquid and high mechanical strength is preferable. Specifically, SUS, Ti, alumina, or the like can be preferably used. The cover member 130 is attached to a surface of the liquid ejection unit 300 facing the printing medium.

Here, the cover member 130 is a member having a frame-shaped surface provided with a long opening 131, and the liquid ejection substrate 10 and a sealing material portion (not shown) included in the ejection module 200 are exposed from the opening 131. A frame portion around the opening 131 has a function as a contact surface of a cap member (not shown) that caps the liquid ejection head 3 during printing standby. For this reason, it is preferable to form a closed space during capping by applying an adhesive, a sealing material, a filler, or the like along the periphery of the opening 131 to fill unevenness and gaps on the ejection port surface of the liquid ejection unit 300.

FIG. 4 is a cross-sectional view showing the liquid ejection unit 300. Here, the liquid ejection substrate 10 is shown in a posture in which the ejection port surface faces upward. Also, the cover member 130 is omitted. The common supply flow path 211 and the common collection flow path 212 are formed in the second flow path member 60. The common supply flow path 211 is connected to the liquid ejection substrate 10 of the ejection module 200 via a communication port 51 formed in the first flow path member 50. In the ejection module 200, the liquid ejection substrate 10 is placed on a support plate 30. Although FIG. 4 shows a cross section where the common supply flow path 211 and the communication port 51 are connected, the common collection flow path 212 is also connected to the ejection module 200 via the communication port 51 at another position. Further, the common supply flow path 211 is connected to the negative pressure control unit 230 (high pressure side, weak negative pressure) (see FIG. 3), and the common collection flow path 212 is connected to the negative pressure control unit 230 (low pressure side, strong negative pressure) (see FIG. 3), respectively, via the liquid supply unit 220. Therefore, a flow of liquid flowing from the common supply flow path 211 through the ejection ports of the liquid ejection substrate 10 to the common collection flow path 212 is generated by the differential pressure of the two negative pressure control units 230.

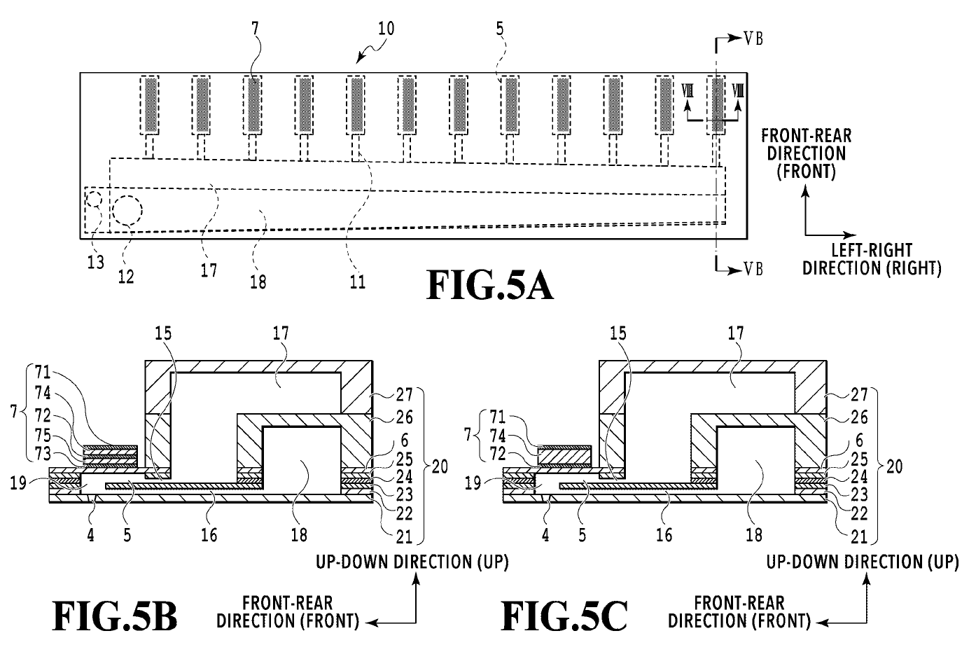

FIGS. 5A to 5C are diagrams showing the liquid ejection substrate 10. FIG. 5A is a perspective view seen from above, and FIG. 5B is a cross-sectional view taken along line VB-VB of FIG. 5A. Further, FIG. 5C shows the same portion as FIG. 5B but shows a state where a conventional piezoelectric actuator different from the present embodiment is mounted.

The liquid ejection substrate 10 of the present embodiment includes a flow path forming body 20 and a piezoelectric actuator 7 as shown in FIG. 5B. The flow path forming body 20 is a laminate of a plurality of plates, and the plurality of plates include an ejection port plate 21, a first flow path plate 22 to a fourth flow path plate 25, a vibration plate 6, a fifth flow path plate 26, and a sixth flow path plate 27. These plates are laminated in the up-down direction (first direction) in this order. Hereinafter, the first flow path plate 22 side relative to the ejection port plate 21 is referred to as an upper side, and the opposite side is referred to as a lower side, but the arrangement of the liquid ejection substrate 10 is not limited to this. Holes and grooves of various sizes are formed in each plate by etching or the like.

Inside the flow path forming body 20 in which the respective plates are laminated, holes and grooves are combined to form, for example, a plurality of ejection ports 4, a plurality of individual flow paths 11, a common supply flow path 17, and a common collection flow path 18 as liquid flow paths. The plurality of ejection ports 4 are formed penetrating the ejection port plate 21 in the up-down direction. In the ejection port plate 21, the ejection ports 4 which are through holes are arranged side by side in a left-right direction (second direction) to form an ejection port array. The left-right direction in the present embodiment and subsequent embodiments is a direction orthogonal to the up-down direction and parallel to the longitudinal direction of the liquid ejection substrate 10 as viewed from FIG. 5A, but the left-right direction is not limited to this direction and may be inclined with respect to the longitudinal direction of the liquid ejection substrate 10, for example.

The common supply flow path 17 and the common collection flow path 18 extend in the left-right direction and are connected to the plurality of individual flow paths 11, respectively. A cross-sectional shape of the common supply flow path 17 in a plane orthogonal to the left-right direction is a hook shape in which an upper end thereof bends in a front-rear direction (third direction) and a part thereof is configured on the common collection flow path 18. The common supply flow path 17 is arranged straddling the front direction and the upper direction of the common collection flow path 18. Here, the front-rear direction in the present embodiment and subsequent embodiments is a direction orthogonal to the up-down direction and the left-right direction, but the front-rear direction is not limited to this direction and may intersect the up-down direction and the left-right direction and be inclined, for example. In ink circulation, since ink to be ejected flows in the supply side in addition to circulating ink, it is desirable that the cross-sectional area is larger than that of the collection side.

By making the common supply flow path 17 into the aforementioned hook shape, it becomes possible to secure a large cross-sectional area of the common supply flow path 17 with a small space. The common supply flow path 17 has a supply opening 12, and the common collection flow path 18 has a collection opening 13. The supply opening 12 is provided at one end in the left-right direction of the common supply flow path 17, and is connected to the flow path member 210 (see FIGS. 3 and 4) via a supply flow path (not shown). The collection opening 13 is provided at an end portion in the left direction which is one direction of the left-right direction of the common collection flow path 18, and is connected to the flow path member 210 (see FIGS. 3 and 4) via a collection flow path (not shown). Note that the other end of the common supply flow path 17 and the other end of the common collection flow path 18 in the left-right direction may be communicated with each other by a bypass path. The individual flow path 11 has an upstream end connected to the common supply flow path 17 and a downstream end connected to the common collection flow path 18, and is connected to the ejection port 4 therebetween.

The individual flow path 11 has an individual supply flow path 15, a pressure chamber 5, an ejection port flow path 19, and an individual collection flow path 16, which are connected in this order. The vibration plate 6 is laminated on the fourth flow path plate 25 and covers an upper end opening of the pressure chamber 5. Note that the vibration plate 6 may be formed integrally with the fourth flow path plate 25. In this case, a portion above the pressure chamber 5 in the fourth flow path plate 25 functions as the vibration plate 6. The piezoelectric actuator 7 is a piezoelectric element that applies pressure for ejecting liquid from the ejection port 4, and details thereof will be described later. Note that the flow path forming body 20 can have electronic devices such as energy generating elements, electric circuits, electric wiring, and temperature sensors arranged on its surface by semiconductor processing, and a material such as a semiconductor substrate capable of forming flow paths by MEMS processing is desirable. Further, for the flow path forming body 20, arbitrary materials can be used, such as a resin substrate in which ejection ports are formed by laser processing, an inorganic plate in which ejection ports are formed by dicing, and a photosensitive resin material in which ejection ports and flow paths are formed by photo-curing. Furthermore, for the flow path forming body 20, materials such as a semiconductor substrate in which ejection ports and flow paths are formed by MEMS processing can be used.

In the present embodiment, a negative pressure pump arranged in the liquid ejection apparatus 1000 is driven. Thereby, due to negative pressure control of the two negative pressure control units 230, a predetermined differential pressure is generated between the supply opening 12 and the collection opening 13, and liquid flows into the common supply flow path 17 via the supply opening 12 and flows through the common supply flow path 17 in the left-right direction. During this time, a part of the liquid flows into the individual flow paths 11. In the individual flow path 11, the liquid flows from the common supply flow path 17 into the individual supply flow path 15, passes through the pressure chamber 5 and the ejection port flow path 19, and flows into the ejection port 4. Here, upon application of ejection pressure to the liquid accommodated in the pressure chamber 5 by the drive element 7, the liquid is ejected from the ejection port 4.

The liquid that has not been ejected from the ejection port 4 flows through the individual collection flow path 16 and flows into the common collection flow path 18. The liquid flows from the common collection flow path 18 to the collection opening 13. Then, the liquid is discharged from the collection opening 13 via the collection flow path and returns to the negative pressure pump. Thereby, the liquid that has not been ejected from the opening of the ejection port 4 circulates between the liquid ejection substrate 10 and the outside. In the above description, the configuration in which the differential pressure is generated by the negative pressure pump and the two negative pressure control units 230 has been described, but a pressurizing pump may be used instead of the negative pressure pump. Further, as a circulation method in the present embodiment, a differential pressure may be generated using a pressurizing pump and a negative pressure pump. Furthermore, circulation may be performed by other differential pressure generating means.

As described above, the common supply flow path 17 and the common collection flow path 18 extend long in the left-right direction, and have the supply opening 12 and the collection opening 13 at one end thereof, respectively, from which ink is circulated. In the present embodiment, the supply opening 12 and the collection opening 13 are provided at the same end in the left-right direction, but they may be provided at opposite ends. In a case where circulation is performed by providing the supply opening 12 and the collection opening 13 at the end in this way, since the pressure loss differs depending on the distance from the end to each individual flow path 11, the amount of ink flowing through each individual flow path 11 differs. For example, in a case where the supply opening 12 and the collection opening 13 are at the end on the same side as in the present embodiment, the flow rate decreases as the distance from the opening increases, that is, toward the individual flow path 11 on the right side in the drawing.

On the other hand, in a case where the supply opening 12 is provided at one end and the collection opening 13 is provided at the other end, the flow rate is large in the individual flow path 11 at the center in the left-right direction, and the flow rate of the individual flow path 11 decreases toward the ends. If the flow rate of ink circulating through the individual flow path 11 is small, circulation in the individual flow path 11 is not sufficiently performed, and ink may stagnate for a long time. Physical properties such as viscosity of this ink change with the passage of time; upon ejection, intended droplets are not ejected, which may degrade image quality. Further, in a case of stagnation for a longer period, there is a concern that the ink dries near the ejection port and ejection itself is not performed. Thus, the difference in circulation flow rate depending on the position of the individual flow path 11 in the left-right direction affects image quality of the head and head life, which depends on the state of the individual flow path 11 having the smallest circulation flow rate.

In order to improve such a difference in circulation flow rate in each individual flow path, there is a non-ejection vibration drive in which the piezoelectric actuator 7 is driven to vibrate the meniscus to an extent that liquid is not ejected from the ejection port 4. By this drive, ink near the ejection port 4 can be moved, physical properties of the ink can be uniformized, and drying can be prevented. By adjusting the frequency of this non-ejection vibration drive according to the circulation flow rate, it becomes possible to perform intended ejection from all ejection ports 4. However, since the life of the piezoelectric actuator 7 is shortened by adding this non-ejection vibration drive, the frequency of the non-ejection vibration drive affects the life of the piezoelectric element, that is, the life of the head, which depends on the piezoelectric actuator 7 having the largest number of drives.

Here, a conventional piezoelectric actuator will be described. In FIG. 5C, a piezoelectric actuator 7 includes a first electrode 71, a piezoelectric layer 74, and a second electrode 72, which are arranged in this order. The second electrode 72 is provided for each pressure chamber 5 and is arranged on the vibration plate 6 via an insulating film. The piezoelectric layer 74 is provided for each pressure chamber 5 and is arranged on the second electrode 72 so as to overlap the pressure chamber 5. The first electrode 71 is provided for each pressure chamber 5 and is arranged on the piezoelectric layer 74. At this time, one piezoelectric actuator 7 is constituted by one first electrode 71, second electrode 72, and a portion of the piezoelectric layer 74 (active portion) sandwiched therebetween. The first electrode 71 is electrically connected to the electric wiring board 90 (see FIG. 3). This electric wiring board 90 receives a control signal from the control unit in the liquid ejection apparatus 1000, generates a drive signal (voltage signal), and applies it to the first electrode 71. In contrast, the second electrode 72 is always held at a ground potential. In accordance with the drive signal, a potential difference is generated between the first electrode 71 and the second electrode 72, and the active portion of the piezoelectric layer 74 expands and contracts in a plane direction together with the first electrode 71 and the second electrode 72. In response to this, the vibration plate 6 deforms cooperatively and changes in a direction to increase or decrease the volume of the pressure chamber 5. Thereby, ejection pressure for ejecting liquid from the ejection port 4 is applied to the pressure chamber 5. In a case where the non-ejection vibration drive is performed, a drive signal having a lower voltage than that in a case where the ejection operation is performed is applied to the first electrode 71. Thereby, vibration to an extent that ejection is not performed from the ejection port 4 occurs in the pressure chamber 5, and ink in the vicinity of the ejection port is agitated.

On the other hand, the piezoelectric actuator 7 in the present embodiment is arranged on the upper surface of the vibration plate 6 in the up-down direction as shown in FIG. 5B. The piezoelectric actuator 7 has a first electrode 71, a piezoelectric layer 74, a second electrode 72, a piezoelectric layer 75, and a third electrode 73, and these are arranged in this order. The piezoelectric layers 74 to 75 have the same shape and size as each other in a plane along the left-right direction and the front-rear direction, and define an outer shape of the piezoelectric actuator 7 which is substantially rectangular as viewed from the up-down direction. In order to realize an equivalent ejection amount, the thickness of the entire piezoelectric actuator 7 in the present embodiment is the same as the thickness of the entire conventional piezoelectric actuator 7. Also, the thicknesses of the piezoelectric layer 74 and the piezoelectric layer 75 in the present embodiment are the same, but the thickness ratio is not limited to this.

Since the thickness of one layer is thinner than that of the conventional piezoelectric layer, for example, in causing deformation necessary for ejection, it is possible to deform with a lower voltage than in the case of a single layer. This is the same in the non-ejection vibration drive described above. Thus, by lowering the voltage applied to the piezoelectric element, it becomes possible to extend the life of the piezoelectric element. Thereby, it is possible to perform a sufficient number of times of non-ejection vibration drive and ejection vibration drive as compared with the conventional piezoelectric element, and it becomes possible to realize a liquid ejection head with a long life in combination with the above-described ink circulation.

In the present embodiment, all piezoelectric actuators 7 of the liquid ejection substrate 10 have this configuration. However, the non-ejection vibration drive may be performed only for the piezoelectric actuator 7 corresponding to an individual flow path 11 for which the circulation flow rate is determined to be less than a certain amount in advance at the time of design.

Also, the non-ejection vibration drive may be performed only for the piezoelectric actuator 7 corresponding to a flow path for which fluid resistance from the negative pressure control unit to the pressure chamber is specified to be large in advance at the time of design.

In this way, the piezoelectric actuator has a piezoelectric body having a first piezoelectric layer and a second piezoelectric layer stacked in the up-down direction, the first piezoelectric layer is provided sandwiched between a first electrode and a second electrode in the up-down direction, and the second piezoelectric layer is configured to be provided sandwiched between the second electrode and a third electrode in the up-down direction. Thereby, in a liquid ejection apparatus that performs vibration of a meniscus and circulation of ink in a flow path using a piezoelectric actuator, it is possible to provide a technique for promoting a longer life of a liquid ejection head.

### Second Embodiment

Hereinafter, a second embodiment of the present disclosure will be described with reference to the drawings. Since the basic configuration of the present embodiment is the same as that of the first embodiment, characteristic configurations will be described below.

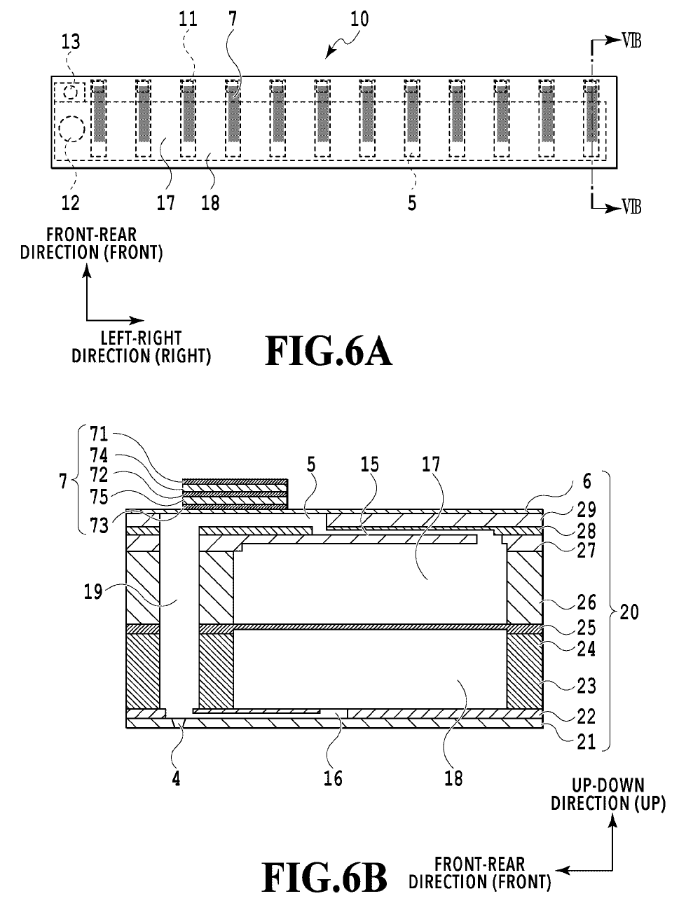

FIGS. 6A and 6B are diagrams showing a liquid ejection substrate 10 of the present embodiment. FIG. 6A is a perspective view of the liquid ejection substrate 10 seen from above, and FIG. 6B is a cross-sectional view taken along line VIB-VIB of FIG. 6A. The liquid ejection substrate 10 of the present embodiment includes a flow path forming body 20 and a piezoelectric actuator 7 as shown in FIG. 6B. The flow path forming body 20 is a laminate of a plurality of plates, and the plurality of plates include an ejection port plate 21, a first flow path plate 22 to an eighth flow path plate 29, and a vibration plate 6. These plates are laminated in the up-down direction in this order. Holes and grooves of various sizes are formed in each plate by etching or the like. Inside the flow path forming body 20 in which the respective plates are laminated, holes and grooves are combined to form, for example, a plurality of ejection ports 4, a plurality of individual flow paths 11, a common supply flow path 17, and a common collection flow path 18 as liquid flow paths.

The plurality of ejection ports 4 are formed penetrating the ejection port plate 21 in the up-down direction. In the ejection port plate 21, the ejection ports 4 which are through holes are arranged side by side in the left-right direction to form an ejection port array. The common supply flow path 17 and the common collection flow path 18 extend long in the left-right direction and are connected to the plurality of individual flow paths 11, respectively. The common supply flow path 17 is laminated on the common collection flow path 18. In the first embodiment, although a large flow path cross-sectional area of the common supply flow path 17 can be secured, since a portion of the individual flow path 11 protrudes in the front direction, a corresponding space is required.

In the configuration of the present embodiment, the common supply flow path 17 and the common collection flow path 18 have the same cross-sectional area, but by arranging a part of the individual flow path 11 laminated on the common supply flow path 17 and the common collection flow path 18, it becomes possible to make the size of the liquid ejection substrate 10 compact in the front-rear direction. The common supply flow path 17 has a supply opening 12, and the common collection flow path 18 has a collection opening 13. The supply opening 12 is provided at one end in the left-right direction of the common supply flow path 17, and is connected to the flow path member 210 (see FIGS. 3 and 4) via a supply flow path (not shown). The collection opening 13 is provided at one end in the left-right direction of the common collection flow path 18, and is connected to the flow path member 210 (see FIGS. 3 and 4) via a collection flow path (not shown). Note that the other end of the common supply flow path 17 and the other end of the common collection flow path 18 in the left-right direction may be communicated with each other by a bypass path.

The individual flow path 11 has an upstream end connected to the common supply flow path 17 and a downstream end connected to the common collection flow path 18, and is connected to the ejection port 4 therebetween. The individual flow path 11 has an individual supply flow path 15, a pressure chamber 5, an ejection port flow path 19, and an individual collection flow path 16, which are connected in this order. In the liquid ejection substrate 10, in the present embodiment, a negative pressure pump arranged in the liquid ejection apparatus 1000 is driven. Thereby, due to negative pressure control of the two negative pressure control units 230, a differential pressure is generated between the supply opening 12 and the collection opening 13, and liquid flows into the common supply flow path 17 via the supply opening 12 and flows through the common supply flow path 17 in the left-right direction. During this time, a part of the liquid flows into the individual flow paths 11. In the individual flow path 11, the liquid flows from the common supply flow path 17 into the individual supply flow path 15, passes through the pressure chamber 5 and the ejection port flow path 19, and flows into the ejection port 4. Here, upon application of ejection pressure to the pressure chamber 5 by the drive element 7, the liquid is ejected from the ejection port 4.

The liquid that has not been ejected from the ejection port 4 flows into the common collection flow path 18 via the individual collection flow path 16. The liquid flows from the common collection flow path 18 to the collection opening 13. Then, the liquid is discharged from the collection opening 13 via the collection flow path and returns to the negative pressure pump. Thereby, the liquid that has not been ejected from the opening of the ejection port 4 circulates between the liquid ejection substrate 10 and the outside. In the above description, the configuration in which the differential pressure is generated by the negative pressure pump and the two negative pressure control units 230 has been described, but a pressurizing pump may be used instead of the negative pressure pump. Further, as a circulation method in the present embodiment, a differential pressure may be generated using a pressurizing pump and a negative pressure pump. Furthermore, circulation may be performed by other differential pressure generating means. The vibration plate 6 is laminated on the eighth flow path plate 29 and covers an upper end opening of the pressure chamber 5. Note that the vibration plate 6 may be formed integrally with the eighth flow path plate 29. In this case, a portion above the pressure chamber 5 in the eighth flow path plate 29 functions as the vibration plate 6.

Note that the flow path forming body 20 can have electronic devices such as energy generating elements, electric circuits, electric wiring, and temperature sensors arranged on its surface by semiconductor processing, and a material such as a semiconductor substrate capable of forming flow paths by MEMS processing is desirable. The piezoelectric actuator 7 is the same as in the first embodiment. Even in the flow path shape as described in the present embodiment, it becomes possible to realize a liquid ejection head with a long life by using the piezoelectric actuator 7 of the laminated structure described above.

Also in the present embodiment, the non-ejection vibration drive may be performed only for the piezoelectric actuator 7 corresponding to an individual flow path 11 for which the circulation flow rate is determined to be less than a certain amount or an individual flow path 11 having a large fluid resistance specified in advance at the time of design.

### Third Embodiment

Hereinafter, a third embodiment of the present disclosure will be described with reference to the drawings. Since the basic configuration of the present embodiment is the same as that of the first embodiment, characteristic configurations will be described below.

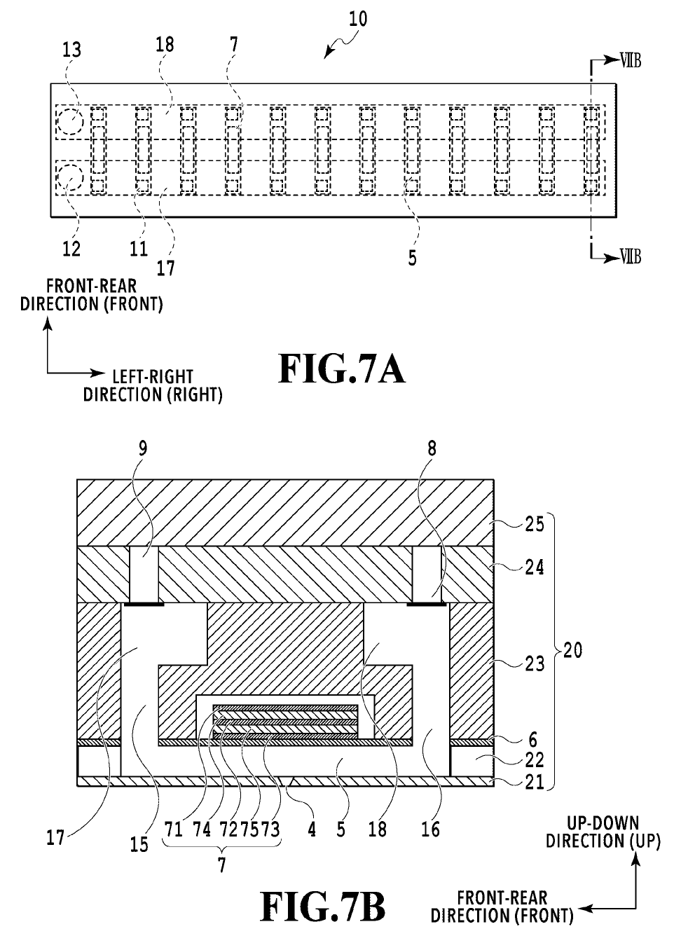

FIGS. 7A and 7B are diagrams showing a liquid ejection substrate 10 of the present embodiment. FIG. 7A is a perspective view of the liquid ejection substrate 10 seen from above, and FIG. 7B is a cross-sectional view taken along line VIIB-VIIB of FIG. 7A. The liquid ejection substrate 10 of the present embodiment includes a flow path forming body 20 and a piezoelectric actuator 7 as shown in FIG. 7B. The flow path forming body 20 is a laminate of a plurality of plates, and the plurality of plates include an ejection port plate 21, a first flow path plate 22, a vibration plate 6, and a second flow path plate 23 to a fourth flow path plate 25. These plates are laminated in the up-down direction in this order. Holes and grooves of various sizes are formed in each plate by etching or the like. Inside the flow path forming body 20 in which the respective plates are laminated, holes and grooves are combined to form, for example, a plurality of ejection ports 4, a plurality of individual flow paths 11, a common supply flow path 17, and a common collection flow path 18 as liquid flow paths. The plurality of ejection ports 4 are formed penetrating the ejection port plate 21 in the up-down direction.

In the ejection port plate 21, the ejection ports 4 which are through holes are arranged side by side in the left-right direction to form an ejection port array. The flow path forming body 20 can have electronic devices such as energy generating elements, electric circuits, electric wiring, and temperature sensors arranged on its surface by semiconductor processing, and a material such as a semiconductor substrate capable of forming flow paths by MEMS processing is desirable. Also, arbitrary materials can be used, such as a resin substrate in which ejection ports are formed by laser processing, an inorganic plate in which ejection ports are formed by dicing, a photosensitive resin material in which ejection ports and flow paths are formed by photo-curing, or a semiconductor substrate in which ejection ports and flow paths are formed by MEMS processing. The common supply flow path 17 and the common collection flow path 18 extend long in the left-right direction and are connected to the plurality of individual flow paths 11, respectively.

The common supply flow path 17 is arranged adjacent to the common collection flow path 18 in the front-rear direction at the same position in the up-down direction. The common supply flow path 17 has a supply opening 12, and the common collection flow path 18 has a collection opening 13. The supply opening 12 is provided at one end in the left-right direction of the common supply flow path 17, and is connected to the flow path member 210 (see FIGS. 3 and 4) via a supply flow path (not shown). The collection opening 13 is provided at one end in the left-right direction (an end in one direction) of the common collection flow path 18, and is connected to the flow path member 210 (see FIGS. 3 and 4) via a collection flow path (not shown).

Note that the other end of the common supply flow path 17 and the other end of the common collection flow path 18 in the left-right direction (an end in the other direction) may be communicated with each other by a bypass path. The individual flow path 11 has an upstream end connected to the common supply flow path 17 and a downstream end connected to the common collection flow path 18, and is connected to the ejection port 4 therebetween.

The individual flow path 11 has an individual supply flow path 15, a pressure chamber 5, and an individual collection flow path 16, which are connected in this order. In the liquid ejection substrate 10, in the present embodiment, a negative pressure pump arranged in the liquid ejection apparatus 1000 is driven. Thereby, due to negative pressure control of the two negative pressure control units 230, a differential pressure is generated between the supply opening 12 and the collection opening 13, and liquid flows into the common supply flow path 17 via the supply opening 12 and flows through the common supply flow path 17 in the left-right direction. During this time, a part of the liquid flows into the individual flow paths 11. In the individual flow path 11, the liquid flows from the common supply flow path 17 into the individual supply flow path 15, and flows into the ejection port 4 through the pressure chamber 5.

Here, upon application of ejection pressure to the pressure chamber 5 by the drive element 7, the liquid is ejected from the ejection port 4. The liquid that has not been ejected from the ejection port 4 flows through the individual collection flow path 16 and flows into the common collection flow path 18. The liquid flows from the common collection flow path 18 to the collection opening 13. Then, the liquid is discharged from the collection opening 13 via the collection flow path and returns to the negative pressure pump (decompression pump). Thereby, the liquid that has not been ejected from the opening of the ejection port 4 circulates between the liquid ejection substrate 10 and the outside. In the above description, the configuration in which the differential pressure is generated by the negative pressure pump and the two negative pressure control units 230 has been described, but a pressurizing pump may be used instead of the negative pressure pump. Further, as a circulation method in the present embodiment, a differential pressure may be generated using a pressurizing pump and a negative pressure pump. Furthermore, circulation may be performed by other differential pressure generating means.

The vibration plate 6 is laminated on the first flow path plate 22 and covers an upper end opening of the pressure chamber 5. Note that the vibration plate 6 may be formed integrally with the first flow path plate 22. In this case, a portion above the pressure chamber 5 in the first flow path plate 22 functions as the vibration plate 6. Note that the flow path forming body 20 can have electronic devices such as energy generating elements, electric circuits, electric wiring, and temperature sensors arranged on its surface by semiconductor processing, and a material such as a semiconductor substrate capable of forming flow paths by MEMS processing is desirable.

In the third flow path plate 24, a damper chamber 9 is configured at a position facing the individual supply flow path 15 and the individual collection flow path 16. The damper chamber 9 is a groove portion configured in the third flow path plate 24, and boundaries with the common supply flow path 17 and the common collection flow path 18 are sealed with a damper film 8. As a material of the damper film 8, it is preferable to use a metal thin film or an inorganic thin film resistant to organic solvents. Further, in the fourth flow path plate 25, an atmosphere communication hole (not shown) is formed on a surface facing the damper film 8. The configuration of the piezoelectric actuator 7 is the same as in the first embodiment. By arranging the piezoelectric actuator 7 in the vicinity of the ejection port 4 as in the present embodiment, it becomes possible to efficiently apply force generated from the piezoelectric actuator 7 to the ejection port 4.

Even in the flow path shape as described in the present embodiment, it becomes possible to realize a liquid ejection head with a long life by using the piezoelectric actuator 7 of the laminated structure described above. It goes without saying that the damper film 8, the damper chamber 9, and the atmosphere communication hole described in the present embodiment are applicable to other embodiments or various flow path forming bodies 20 not described here.

Also in the present embodiment, the non-ejection vibration drive may be performed only for the piezoelectric actuator 7 corresponding to an individual flow path 11 for which the circulation flow rate is determined to be less than a certain amount or an individual flow path 11 having a large fluid resistance specified in advance at the time of design.

### First Modification

For the electrodes in the piezoelectric actuator 7 described so far, an example has been shown in which the first electrode 71, the second electrode 72, and the third electrode 73 are arranged over the entire area of the piezoelectric actuator 7. In this case, although lowering the applied voltage is effective in extending the life of the actuator, since the entire piezoelectric layer expands and contracts upon application of the voltage, there is a possibility that the force pushing the vibration plate cannot be sufficiently exhibited. Therefore, there is a method of effectively applying force to the vibration plate by arranging the electrodes in a divided manner and limiting the portion that expands and contracts, and an example thereof will be described in the first modification.

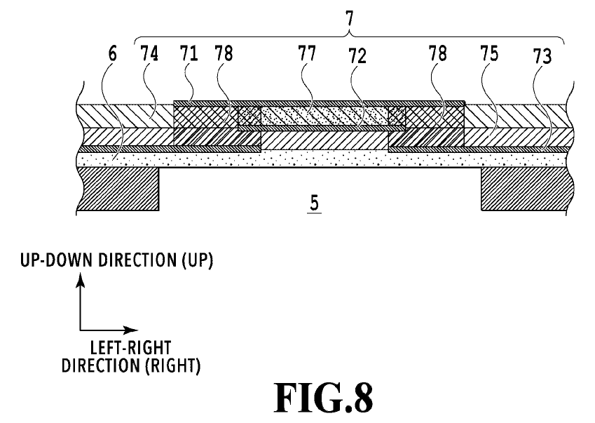

FIG. 8 is a diagram showing a cross section taken along line VIII-VIII of FIG. 5A. The piezoelectric actuator 7 is arranged on the upper surface of the vibration plate 6 in the up-down direction. The piezoelectric actuator 7 has a first electrode 71, a piezoelectric layer 74, a second electrode 72, a piezoelectric layer 75, and a third electrode 73, and these are arranged in this order. The first electrode 71 is arranged so as to overlap the pressure chamber 5 as viewed from the up-down direction, and its length in the left-right direction is shorter than that of the pressure chamber 5. The second electrode 72 is arranged so as to overlap the first electrode 71 as viewed from the up-down direction, and its length in the left-right direction is shorter than that of the first electrode 71. The third electrode 73 is arranged so as to be divided in the left-right direction as viewed from the up-down direction, and divided inner end portions are arranged inside the second electrode 72. Portions other than both end portions in the left-right direction of the second electrode 72 overlap the first electrode 71 and do not overlap the third electrode 73.

Next, an operation of the piezoelectric actuator 7 during ejection of ink from the ejection port 4 will be described. Before ejection is performed, a low potential (GND potential) is applied to the first electrode 71 and the third electrode 73, and a high potential (VDD potential) higher than the GND potential is applied to the second electrode 72. In the piezoelectric actuator 7, an upward electric field equal to the polarization direction is generated in a region 77 (hereinafter referred to as a first active portion) where the first electrode 71 and the second electrode 72 overlap as viewed from the up-down direction due to a potential difference between the first electrode 71 and the second electrode 72. Then, the first active portion 77 contracts in a plane direction (a direction along the left-right direction and the front-rear direction). Thereby, a portion overlapping with the pressure chamber 5 in the up-down direction in a laminate composed of the piezoelectric bodies 74, 75 and the vibration plate 6 bends so as to be convex toward the pressure chamber 5 (downward).

At this time, the pressure chamber 5 has a smaller volume compared to a case where the piezoelectric actuator 7 is flat. During ejection of ink from the ejection port 4, first, the potential of the first electrode 71 is switched from the low potential (GND potential) to the high potential (VDD potential). At this time, since the potential difference between the first electrode 71 and the second electrode 72 disappears, the contraction of the first active portion 77 is eliminated. On the other hand, since a potential difference is generated between the first electrode 71 and the third electrode 73, a downward electric field equal to the polarization direction is generated in a region 78 (hereinafter referred to as a second active portion) where the first electrode 71 and the third electrode 73 overlap as viewed from the up-down direction. Then, the second active portion 78 contracts in the plane direction. At this time, the piezoelectric actuator 7 enters a flat state without bending so that the portion overlapping with the pressure chamber 5 in the up-down direction becomes convex in a direction away from the pressure chamber 5 (upward).

Thereby, the volume of the pressure chamber 5 becomes larger than before ejection. Thereafter, the potential of the first electrode 71 is switched from the high potential (VDD potential) to the low potential (GND potential). At this time, in the piezoelectric actuator 7, since the potential difference between the first electrode 71 and the third electrode 73 disappears, the contraction of the second active portion 78 is eliminated. On the other hand, since a potential difference is generated between the first electrode 71 and the second electrode 72, an upward electric field equal to the polarization direction is generated in the first active portion 77, and the first active portion 77 contracts in the plane direction. Thereby, the portion overlapping with the pressure chamber 5 in the up-down direction in the piezoelectric actuator 7 bends so as to be convex toward the pressure chamber 5 (downward). At this time, since the volume of the pressure chamber 5 greatly decreases, a large pressure is applied to the ink in the pressure chamber 5, and the ink is ejected from the ejection port 4 located below the pressure chamber 5. In this way, by performing the drive as described above using the divided electrodes, it becomes possible to effectively deform the vibration plate 6.

In the present embodiment, the inner end portions of the third electrode 73 seen from the front-rear direction are arranged inside the end portions of the second electrode 72, but the inner end portions of the third electrode 73 may be at the same positions as the end portions of the second electrode 72 in the left-right direction, or may be outside the second electrode 72 if they are in the vicinity. By arranging the electrodes in this way, an arrangement is achieved in which the first active portion 77 and the second active portion 78 overlap, or are adjacent to or in the vicinity of each other, so that a portion where polarization is uncertain is generated between the first active portion 77 and the second active portion 78, and deterioration of the piezoelectric actuator 7 can be suppressed.

On the other hand, in this electrode arrangement, driving the piezoelectric actuator 7 may cause the amount of deformation of the piezoelectric actuator 7 to increase as the number of drives increases. With an increase in the amount of deformation, ejection speed becomes larger than assumed at the time of design in the ejection vibration drive. On the other hand, in the non-ejection vibration drive, meniscus vibration becomes larger than assumed at the time of design, and there is a possibility that ink leaks from the ejection port. Hereinafter, in this specification, the electrode arrangement of the first modification is referred to as an IN type.

### Second Modification

In a second modification, another example in which electrodes are arranged in a divided manner will be described.

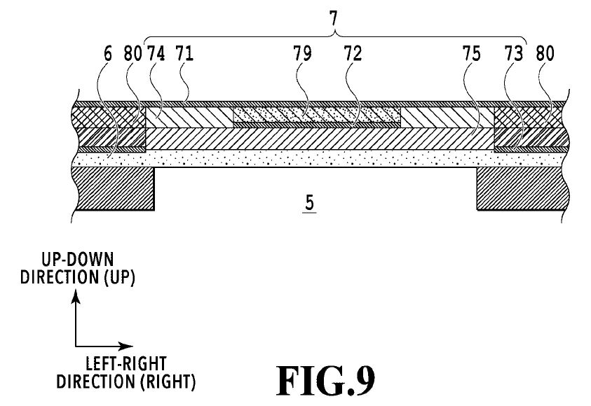

FIG. 9 is a diagram showing a cross section taken along line VIII-VIII of FIG. 5A. The piezoelectric actuator 7 is arranged on the upper surface of the vibration plate 6 in the up-down direction. The piezoelectric actuator 7 has a first electrode 71, a piezoelectric layer 74, a second electrode 72, a piezoelectric layer 75, and a third electrode 73, and these are arranged in this order. The first electrode 71 is arranged over the entire area of the piezoelectric layer 74 in the left-right direction. The second electrode 72 is arranged so as to overlap the pressure chamber 5 as viewed from the up-down direction, and its length in the left-right direction is shorter than that of the pressure chamber 5. The third electrode 73 is arranged so as to be divided in the left-right direction as viewed from the up-down direction, and is arranged outside the pressure chamber 5 as viewed from the front-rear direction.

Next, an operation of the piezoelectric actuator 7 during ejection of ink from the ejection port 4 will be described. Before ejection is performed, a low potential (GND potential) is applied to the first electrode 71 and the third electrode 73. A high potential (VDD potential) higher than the GND potential is applied to the second electrode 72. In the piezoelectric actuator 7, an upward electric field equal to the polarization direction is generated in a region 79 (hereinafter referred to as a first active portion) where the first electrode 71 and the second electrode 72 overlap as viewed from the up-down direction due to a potential difference between the first electrode 71 and the second electrode 72. Thereby, the first active portion 79 contracts in the plane direction (the direction along the left-right direction and the front-rear direction). As a result, a portion overlapping with the pressure chamber 5 in the up-down direction in a laminate composed of the piezoelectric bodies 74, 75 and the vibration plate 6 bends so as to be convex toward the pressure chamber 5 (downward).

At this time, the pressure chamber 5 has a smaller volume compared to a case where the piezoelectric actuator 7 is flat. During ejection of ink from the ejection port 4, first, the potential of the first electrode 71 is switched from the low potential (GND potential) to the high potential (VDD potential). At this time, since the potential difference between the first electrode 71 and the second electrode 72 disappears, the contraction of the first active portion 79 is eliminated. On the other hand, since a potential difference is generated between the first electrode 71 and the third electrode 73, a downward electric field equal to the polarization direction is generated in a region 80 (hereinafter referred to as a second active portion) where the first electrode 71 and the third electrode 73 overlap as viewed from the up-down direction, and the second active portion 80 contracts in the plane direction. At this time, the piezoelectric actuator 7 enters a flat state without bending so that the portion overlapping with the pressure chamber 5 in the up-down direction becomes convex in a direction away from the pressure chamber 5 (upward). Thereby, the volume of the pressure chamber 5 becomes larger than before ejection.

Thereafter, the potential of the first electrode 71 is switched from the high potential (VDD potential) to the low potential (GND potential). At this time, in the piezoelectric actuator 7, since the potential difference between the first electrode 71 and the third electrode 73 disappears, the contraction of the second active portion 80 is eliminated. On the other hand, since a potential difference is generated between the first electrode 71 and the second electrode 72, an upward electric field equal to the polarization direction is generated in the first active portion 79, and the first active portion 79 contracts in the plane direction. Thereby, the portion overlapping with the pressure chamber 5 in the up-down direction in the piezoelectric actuator 7 bends so as to be convex toward the pressure chamber 5 (downward). At this time, since the volume of the pressure chamber 5 greatly decreases, a large pressure is applied to the ink in the pressure chamber 5, and the ink is ejected from the ejection port 4 located below the pressure chamber 5.

In this way, by performing the drive as described above using the divided electrodes, it becomes possible to effectively deform the vibration plate 6. By performing the drive as described above using the divided electrodes, it becomes possible to effectively deform the vibration plate 6. In the present embodiment, the inner end portions of the third electrode 73 seen from the front-rear direction are arranged outside the pressure chamber 5, but they may be inside the pressure chamber 5 if they are sufficiently separated from the end portions of the second electrode 72 in the left-right direction.

By arranging the electrodes in this way, an arrangement is achieved in which the distance between the first active portion 79 and the second active portion 80 is sufficiently wide, and repeatedly driving the piezoelectric actuator 7 may cause the amount of deformation of the piezoelectric actuator 7 to decrease as the number of drives increases. With a decrease in the amount of deformation, ejection speed becomes smaller than assumed at the time of design in the ejection vibration drive. On the other hand, in the non-ejection vibration drive, meniscus vibration becomes smaller than assumed at the time of design, and there is a possibility that ink agitation in the vicinity of the ejection port becomes insufficient. Hereinafter, in this specification, the electrode arrangement of the second modification is referred to as an OUT type.

### Third Modification

In a third modification, another example in which electrodes are arranged in a divided manner (left-right direction INOUT type) will be described.

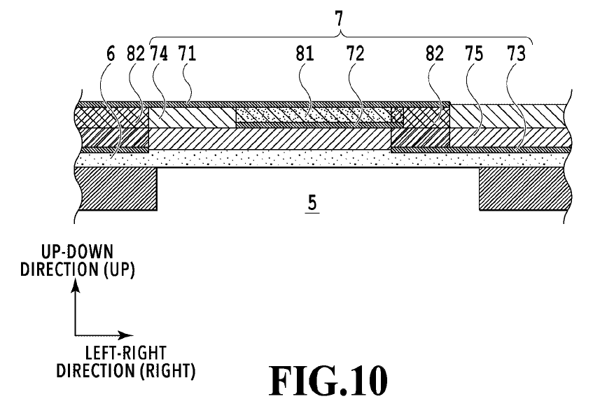

FIG. 10 is a diagram showing a cross section taken along line VIII-VIII of FIG. 5A. The piezoelectric actuator 7 is arranged on the upper surface of the vibration plate 6 in the up-down direction. The piezoelectric actuator 7 has a first electrode 71, a piezoelectric layer 74, a second electrode 72, a piezoelectric layer 75, and a third electrode 73, and these are arranged in this order. The arrangement of the first electrode 71, the second electrode 72, and the third electrode 73 in the present modification is such that the right side from the center of the pressure chamber is the IN type arrangement, and the left side from the center of the pressure chamber is the OUT type arrangement as viewed from the front-rear direction. It goes without saying that this arrangement holds even if the left and right are reversed.

Next, an operation of the piezoelectric actuator 7 during ejection of ink from the ejection port 4 will be described. Before ejection is performed, a low potential (GND potential) is applied to the first electrode 71 and the third electrode 73. A high potential (VDD potential) higher than the GND potential is applied to the second electrode 72. In the piezoelectric actuator 7, an upward electric field equal to the polarization direction is generated in a region 81 (hereinafter referred to as a first active portion) where the first electrode 71 and the second electrode 72 overlap as viewed from the up-down direction due to a potential difference between the first electrode 71 and the second electrode 72. Thereby, the first active portion 81 contracts in the plane direction (the direction along the left-right direction and the front-rear direction). As a result, a portion overlapping with the pressure chamber 5 in the up-down direction in the piezoelectric actuator 7 bends so as to be convex toward the pressure chamber 5 (downward). At this time, the pressure chamber 5 has a smaller volume compared to a case where the piezoelectric actuator 7 is flat.

During ejection of ink from the ejection port 4, first, the potential of the first electrode 71 is switched from the low potential (GND potential) to the high potential (VDD potential). At this time, since the potential difference between the first electrode 71 and the second electrode 72 disappears, the contraction of the first active portion 81 is eliminated. On the other hand, since a potential difference is generated between the first electrode 71 and the third electrode 73, a downward electric field equal to the polarization direction is generated in a region 82 (hereinafter referred to as a second active portion) where the first electrode 71 and the third electrode 73 overlap as viewed from the up-down direction, and the second active portion 82 contracts in the plane direction. At this time, the piezoelectric actuator 7 enters a flat state without bending so that the portion overlapping with the pressure chamber 5 in the up-down direction becomes convex in a direction away from the pressure chamber 5 (upward). Thereby, the volume of the pressure chamber 5 becomes larger than before ejection.

Thereafter, the potential of the first electrode 71 is switched from the high potential (VDD potential) to the low potential (GND potential). At this time, in the piezoelectric actuator 7, since the potential difference between the first electrode 71 and the third electrode 73 disappears, the contraction of the second active portion 82 is eliminated. On the other hand, since a potential difference is generated between the first electrode 71 and the second electrode 72, an upward electric field equal to the polarization direction is generated in the first active portion 81, and the first active portion 81 contracts in the plane direction. Thereby, the portion overlapping with the pressure chamber 5 in the up-down direction in the piezoelectric actuator 7 bends so as to be convex toward the pressure chamber 5 (downward). At this time, since the volume of the pressure chamber 5 greatly decreases, a large pressure is applied to the ink in the pressure chamber 5, and the ink is ejected from the ejection port 4 located below the pressure chamber 5.

As described above, in the IN type electrode arrangement, the amount of deformation of the piezoelectric actuator 7 increases as it is repeatedly driven, and in the OUT type electrode arrangement, the amount of deformation of the piezoelectric actuator 7 tends to decrease as it is repeatedly driven. By arranging the electrode arrangement of the present modification in the left-right direction respectively, changes in the amount of deformation due to repetition of each other are canceled out, stable deformation can be performed for a long period of time, and the life of the piezoelectric element can be extended.

### Fourth Modification

In a fourth modification, another example in which electrodes are arranged in a divided manner (front-rear direction INOUT type) will be described.

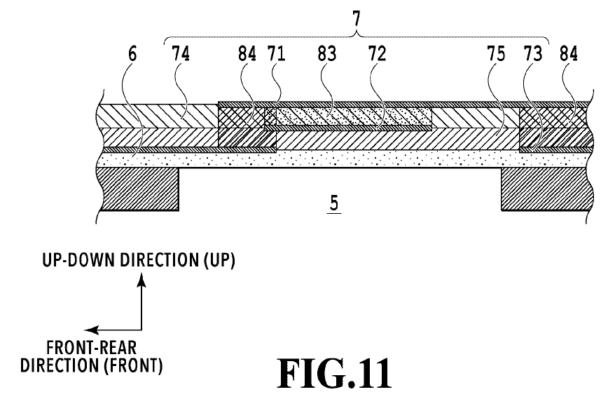

FIG. 11 is a diagram showing a cross section taken along line VB-VB of FIG. 5A. The piezoelectric actuator 7 has a first electrode 71, a piezoelectric layer 74, a second electrode 72, a piezoelectric layer 75, and a third electrode 73, and these are arranged in this order. The arrangement of the first electrode 71, the second electrode 72, and the third electrode 73 in the present example is such that the front side from the center of the pressure chamber is the IN type arrangement, and the rear side from the center of the pressure chamber is the OUT type arrangement as viewed from the left-right direction. It goes without saying that this arrangement holds even if the front and rear are reversed.

Next, an operation of the piezoelectric actuator 7 during ejection of ink from the ejection port 4 will be described. Before ejection is performed, a low potential (GND potential) is applied to the first electrode 71 and the third electrode 73. A high potential (VDD potential) higher than the GND potential is applied to the second electrode 72. In the piezoelectric actuator 7, an upward electric field equal to the polarization direction is generated in a region 83 (hereinafter referred to as a first active portion) where the first electrode 71 and the second electrode 72 overlap as viewed from the up-down direction due to a potential difference between the first electrode 71 and the second electrode 72. Thereby, the first active portion 83 contracts in the plane direction (the direction along the left-right direction and the front-rear direction). As a result, a portion overlapping with the pressure chamber 5 in the up-down direction in the piezoelectric actuator 7 bends so as to be convex toward the pressure chamber 5 (downward). At this time, the pressure chamber 5 has a smaller volume compared to a case where the piezoelectric actuator 7 is flat.

During ejection of ink from the ejection port 4, first, the potential of the first electrode 71 is switched from the low potential (GND potential) to the high potential (VDD potential). At this time, since the potential difference between the first electrode 71 and the second electrode 72 disappears, the contraction of the first active portion 83 is eliminated. On the other hand, since a potential difference is generated between the first electrode 71 and the third electrode 73, a downward electric field equal to the polarization direction is generated in a region 84 (hereinafter referred to as a second active portion) where the first electrode 71 and the third electrode 73 overlap as viewed from the up-down direction, and the second active portion 84 contracts in the plane direction. At this time, the piezoelectric actuator 7 enters a flat state without bending so that the portion overlapping with the pressure chamber 5 in the up-down direction becomes convex in a direction away from the pressure chamber 5 (upward). Thereby, the volume of the pressure chamber 5 becomes larger than before ejection. Thereafter, the potential of the first electrode 71 is switched from the high potential (VDD potential) to the low potential (GND potential). At this time, in the piezoelectric actuator 7, since the potential difference between the first electrode 71 and the third electrode 73 disappears, the contraction of the second active portion 84 is eliminated. On the other hand, since a potential difference is generated between the first electrode 71 and the second electrode 72, an upward electric field equal to the polarization direction is generated in the first active portion 83, and the first active portion 83 contracts in the plane direction. Thereby, the portion overlapping with the pressure chamber 5 in the up-down direction in the piezoelectric actuator 7 bends so as to be convex toward the pressure chamber 5 (downward). At this time, since the volume of the pressure chamber 5 greatly decreases, a large pressure is applied to the ink in the pressure chamber 5, and the ink is ejected from the ejection port 4.

As described above, in the IN type electrode arrangement, the amount of deformation of the piezoelectric actuator 7 increases as it is repeatedly driven, and in the OUT type electrode arrangement, the amount of deformation of the piezoelectric actuator 7 tends to decrease as it is repeatedly driven. By arranging the electrode arrangement of the present modification symmetrically in the front-rear direction, changes in the amount of deformation due to repetition of each other are canceled out, stable deformation can be performed for a long period of time, and the life of the piezoelectric element can be extended.

### Fifth Modification

In a fifth modification, another example in which electrodes are arranged in a divided manner (front-rear left-right direction INOUT type) will be described.

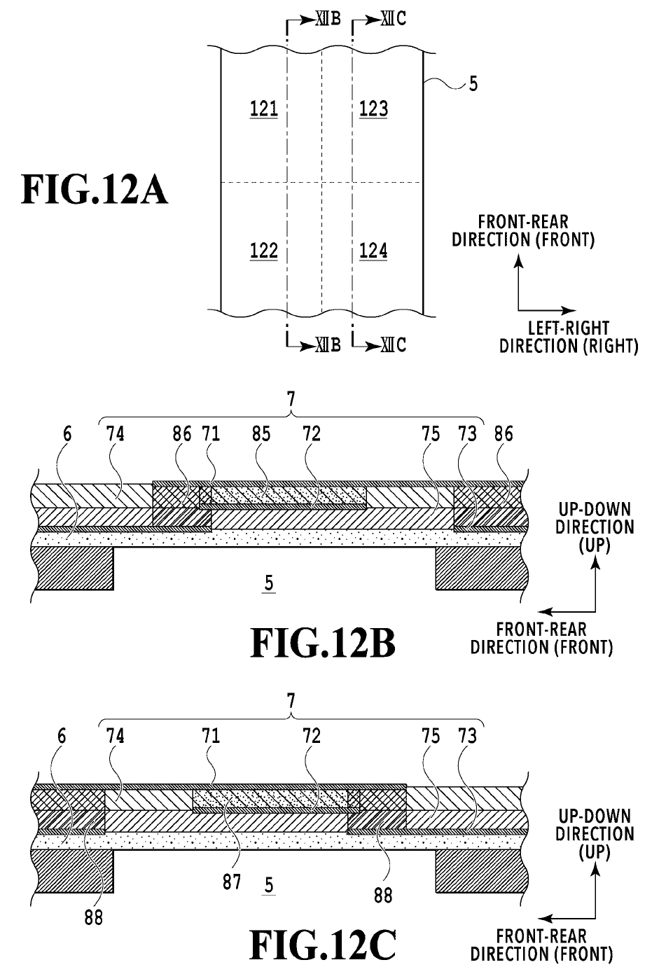

FIG. 12A is a transparent view of a portion of the piezoelectric actuator 7 corresponding to the pressure chamber 5 viewed from the up-down direction. FIG. 12B is a diagram showing a cross section taken along line XIIB-XIIB in FIGS. 12A, and 12C is a diagram showing a cross section taken along line XIIC-XIIC in FIG. 12A. As shown in FIGS. 12B and 12C, the piezoelectric actuator 7 is arranged on the upper surface of the vibration plate 6 in the up-down direction. The piezoelectric actuator 7 has a first electrode 71, a piezoelectric layer 74, a second electrode 72, a piezoelectric layer 75, and a third electrode 73, and these are arranged in this order. Regarding the arrangement of the first electrode 71, the second electrode 72, and the third electrode 73 in the present modification, on the front side from the center of the pressure chamber, a left region 121 is the IN type arrangement and a right region 123 is the OUT type arrangement. Also, on the rear side from the center of the pressure chamber, a left region 122 is the OUT type arrangement and a right region 124 is the IN type arrangement. It goes without saying that this arrangement holds even if the front and rear are reversed.

Next, an operation of the piezoelectric actuator 7 during ejection of ink from the ejection port 4 will be described. Before ejection is performed, a low potential (GND potential) is applied to the first electrode 71 and the third electrode 73. A high potential (VDD potential) higher than the GND potential is applied to the second electrode 72. In the piezoelectric actuator 7, an upward electric field equal to the polarization direction is generated in regions 85, 87 (hereinafter referred to as first active portions) where the first electrode 71 and the second electrode 72 overlap as viewed from the up-down direction due to a potential difference between the first electrode 71 and the second electrode 72. Thereby, the first active portions 85, 87 contract in the plane direction (the direction along the left-right direction and the front-rear direction). Thereby, a portion overlapping with the pressure chamber 5 in the up-down direction in the piezoelectric actuator 7 bends so as to be convex toward the pressure chamber 5 (downward). At this time, the pressure chamber 5 has a smaller volume compared to a case where the piezoelectric actuator 7 is flat.

During ejection of ink from the ejection port 4, first, the potential of the first electrode 71 is switched from the low potential (GND potential) to the high potential (VDD potential). At this time, since the potential difference between the first electrode 71 and the second electrode 72 disappears, the contraction of the first active portions 85, 87 is eliminated. On the other hand, since a potential difference is generated between the first electrode 71 and the third electrode 73, a downward electric field equal to the polarization direction is generated in regions 86, 88 (hereinafter referred to as second active portions) where the first electrode 71 and the third electrode 73 overlap as viewed from the up-down direction, and the second active portions 86, 88 contract in the plane direction. At this time, the piezoelectric actuator 7 enters a flat state without bending so that the portion overlapping with the pressure chamber 5 in the up-down direction becomes convex in a direction away from the pressure chamber 5 (upward). Thereby, the volume of the pressure chamber 5 becomes larger than before ejection.

Thereafter, the potential of the first electrode 71 is switched from the high potential (VDD potential) to the low potential (GND potential). At this time, in the piezoelectric actuator 7, since the potential difference between the first electrode 71 and the third electrode 73 disappears, the contraction of the second active portions 86, 88 is eliminated. On the other hand, since a potential difference is generated between the first electrode 71 and the second electrode 72, an upward electric field equal to the polarization direction is generated in the first active portions 85, 87, and the first active portions 85, 87 contract in the plane direction. Thereby, the portion overlapping with the pressure chamber 5 in the up-down direction in the piezoelectric actuator 7 bends so as to be convex toward the pressure chamber 5 (downward). At this time, since the volume of the pressure chamber 5 greatly decreases, a large pressure is applied to the ink in the pressure chamber 5, and the ink is ejected from the ejection port 4.

As described above, in the IN type electrode arrangement, the amount of deformation of the piezoelectric actuator 7 increases as it is repeatedly driven, and in the OUT type electrode arrangement, the amount of deformation of the piezoelectric actuator 7 tends to decrease as it is repeatedly driven. By arranging the electrode arrangement of the present modification in the front-rear direction and the left-right direction, changes in the amount of deformation due to repetition of each other are canceled out, stable deformation can be performed for a long period of time, and thereby the life of the piezoelectric element can be extended.

Note that the piezoelectric actuator 7 described in the first to fifth modifications is applicable to all the flow path forming bodies 20 described in the first to third embodiments.

In each of the above embodiments, all piezoelectric actuators 7 of the liquid ejection substrate 10 have this configuration. However, an individual flow path 11 having an insufficient circulation flow rate may be determined in advance at the time of design, and the meniscus may be driven without ejecting liquid by a piezoelectric actuator corresponding to the flow path to circulate the liquid in the pressure chamber.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-065444, filed Apr. 11, 2025, which is hereby incorporated by reference herein in its entirety.

What is claimed is:

1. A liquid ejection apparatus comprising:
an ejection port that ejects a liquid;
a pressure chamber that communicates with the ejection port;
a piezoelectric actuator that applies pressure to the liquid accommodated in the pressure chamber;
an individual supply flow path for supplying the liquid to the pressure chamber;
an individual collection flow path for collecting the liquid from the pressure chamber;
a common supply flow path for supplying the liquid in common to a plurality of the individual supply flow paths;
a common collection flow path for collecting the liquid in common from a plurality of the individual collection flow paths;
a differential pressure generation unit that generates a pressure difference between the common supply flow path and the common collection flow path;
a control unit that controls driving of the piezoelectric actuator, wherein
the liquid is caused to flow from the common supply flow path to the common collection flow path via a plurality of the pressure chambers by the differential pressure generated by the differential pressure generation unit, and
the piezoelectric actuator has a plurality of piezoelectric layers stacked in a first direction, and a first electrode, a second electrode, and a third electrode provided at different positions in the first direction so as to sandwich the piezoelectric layers different from each other.

2. The liquid ejection apparatus according to claim 1, wherein
the common supply flow path and the common collection flow path are provided extending in a second direction intersecting the first direction, and
a cross-sectional shape of the common supply flow path viewed from the second direction is a hook shape in which a part thereof is adjacent to the common collection flow path in a third direction intersecting the first direction and the second direction, and a part thereof is adjacent to the common collection flow path in the first direction.

3. The liquid ejection apparatus according to claim 1, wherein
the common supply flow path and the common collection flow path are provided extending in a second direction intersecting the first direction, and
the common supply flow path viewed from the second direction is provided adjacent to the common collection flow path in the first direction.

4. The liquid ejection apparatus according to claim 1, wherein
the common supply flow path and the common collection flow path are provided extending in a second direction intersecting the first direction, and
the common collection flow path and the common supply flow path viewed from the second direction are at the same position in the first direction, and are provided so as to sandwich the plurality of pressure chambers in a third direction intersecting the first direction and the second direction.

5. The liquid ejection apparatus according to claim 1, wherein
the common supply flow path and the common collection flow path are provided extending in a second direction intersecting the first direction, and
as viewed from a third direction intersecting the first direction and the second direction, in the piezoelectric actuator, in the second direction,
a region of the first electrode is inside a region of the pressure chamber,
a region of the second electrode is inside the region of the first electrode, and
the third electrode is divided into a region overlapping with the first electrode and one end portion of the second electrode, and a region overlapping with the first electrode and the other end portion of the second electrode.

6. The liquid ejection apparatus according to claim 1, wherein
the common supply flow path and the common collection flow path are provided extending in a second direction intersecting the first direction, and
as viewed from a third direction intersecting the first direction and the second direction, in the piezoelectric actuator, in the second direction,
a region of the first electrode includes the entire region of the pressure chamber,
a region of the second electrode is inside the region of the pressure chamber, and
the third electrode is divided into a region overlapping with a region on one side of the first electrode outside the region of the pressure chamber, and a region overlapping with a region on the other side of the first electrode outside the region of the pressure chamber.

7. The liquid ejection apparatus according to claim 1, wherein
the common supply flow path and the common collection flow path are provided extending in a second direction intersecting the first direction, and
as viewed from a third direction intersecting the first direction and the second direction, in the piezoelectric actuator, in the second direction,
a region of the first electrode does not include a region on one side of the pressure chamber, and includes a region on the other side,
a region of the second electrode is inside a region of the pressure chamber, and
the third electrode is divided into a region overlapping with the region on the one side of the first electrode and the second electrode inside the region of the pressure chamber, and a region overlapping with the region on the other side of the first electrode outside the region of the pressure chamber.

8. The liquid ejection apparatus according to claim 1, wherein
the common supply flow path and the common collection flow path are provided extending in a second direction intersecting the first direction,
in a first cross section in a third direction intersecting the first direction and the second direction, in the piezoelectric actuator,
a region of the first electrode is inside a region of the pressure chamber,
a region of the second electrode is inside the region of the first electrode, and
the third electrode is divided into a region overlapping with the first electrode and one end portion of the second electrode, and a region overlapping with the first electrode and the other end portion of the second electrode, and
in a second cross section different from the first cross section in the third direction, in the piezoelectric actuator,
a region of the first electrode includes the entire region of the pressure chamber,
a region of the second electrode is inside the region of the pressure chamber, and
the third electrode is divided into a region overlapping with a region on one side of the first electrode outside the region of the pressure chamber, and a region overlapping with a region on the other side of the first electrode outside the region of the pressure chamber.

9. The liquid ejection apparatus according to claim 1, wherein
the common supply flow path and the common collection flow path are provided extending in a second direction intersecting the first direction,
in a first cross section in a third direction intersecting the first direction and the second direction, in the piezoelectric actuator,
an end portion of the first electrode in one direction of the second direction does not overlap with the second electrode in the first direction and has a portion overlapping with the third electrode,
the first electrode has a portion not overlapping with the second electrode and the third electrode in the first direction,
the second electrode has a portion overlapping with the first electrode and not overlapping with the third electrode in the first direction,
the second electrode has a portion overlapping with the first electrode and the third electrode in the first direction at an end portion in the other direction of the second direction, and
the third electrode has a portion not overlapping with the first electrode and the second electrode in the first direction at an end portion in the other direction of the piezoelectric actuator, and
in a second cross section different from the first cross section in the third direction, in the piezoelectric actuator,
an end portion of the first electrode in the other direction does not overlap with the second electrode in the first direction and has a portion overlapping with the third electrode,
the first electrode has a portion not overlapping with the second electrode and the third electrode in the first direction,
the second electrode has a portion overlapping with the first electrode and not overlapping with the third electrode in the first direction,
the second electrode has a portion overlapping with the first electrode and the third electrode in the first direction at an end portion in the one direction, and
the third electrode has a portion not overlapping with the first electrode and the second electrode in the first direction at an end portion in the one direction of the piezoelectric actuator.

10. The liquid ejection apparatus according to claim 1, wherein the control unit controls, for each of the plurality of pressure chambers, ejection vibration drive for driving the piezoelectric actuator to eject the liquid from the ejection port, and non-ejection vibration drive for vibrating a meniscus of the ejection port to an extent that the liquid is not ejected from the ejection port.

11. The liquid ejection apparatus according to claim 10, wherein the control unit performs the non-ejection vibration drive for a pressure chamber having a relatively small flow rate and does not perform the non-ejection vibration drive for a pressure chamber having a relatively large flow rate, among the plurality of pressure chambers,.

12. A liquid ejection head comprising:
an ejection port that ejects a liquid;
a pressure chamber that communicates with the ejection port;
a piezoelectric actuator that applies pressure to the liquid accommodated in the pressure chamber;
an individual supply flow path for supplying the liquid to the pressure chamber;
an individual collection flow path for collecting the liquid from the pressure chamber;
a common supply flow path for supplying the liquid in common to a plurality of the individual supply flow paths; and
a common collection flow path for collecting the liquid in common from a plurality of the individual collection flow paths, wherein
the liquid is caused to flow from the common supply flow path to the common collection flow path via a plurality of the pressure chambers by generating a predetermined differential pressure between the common supply flow path and the common collection flow path, and
the piezoelectric actuator has a plurality of piezoelectric layers stacked in a first direction, and a first electrode, a second electrode, and a third electrode provided at different positions in the first direction so as to sandwich the piezoelectric layers different from each other.

13. The liquid ejection head according to claim 12, further comprising a pressure control unit that generates the predetermined differential pressure between the common supply flow path and the common collection flow path.

14. The liquid ejection head according to claim 12, wherein the predetermined differential pressure is generated by a decompression pump and a pressurizing pump provided externally.
